(19) United States
(12) Patent Application Publication
(10) Pub. No.: US 2018/0243874 A1
(43) Pub. Date: Aug. 30, 2018

(54) WORK METHOD FOR A CARTESIAN MACHINE TOOL

(71) Applicant: HPT SINERGY S.R.L., Padova (IT)

(72) Inventor: Gabriele PICCOLO, Camposampiero (IT)

(21) Appl. No.: 15/903,641

(22) Filed: Feb. 23, 2018

(30) Foreign Application Priority Data
Feb. 24, 2017 (IT) 102017000020977

(51) Int. Cl. B23Q 17/22; B23Q 3/16; B23Q 16/00; G01B 5/008

(52) U.S. Cl. CPC B23Q 17/2233; G01B 5/008; B23Q 16/005; B23Q 3/16

(57) ABSTRACT

A work method for a Cartesian machine tool includes the following steps

starting machining of a workpiece;

carrying out a machining cycle; and

carrying out a qualification operation, i.e., an operation to check a relative positioning system, on board the machine tool, by way of comparison with a positioning system with absolute reference for calibration, which is adapted to check the displacement of the indications of the positioning systems on board the machine, i.e., of the relative reference system, with respect to the positions of an absolute reference system for calibration. The method further includes the steps of

checking the outcome of the qualification operation,

If the qualification operation is passed successfully, then proceed with an operation to measure the workpiece prior to finishing.

If the qualification is not passed, then proceed with a compensation step, which includes one or more compensation operations.

### CROSS-REFERENCE TO RELATED APPLICATIONS

This application is related to, and claims the benefit of, Italian Patent Application No. 102017000020977, filed on Feb. 24, 2017, the contents of which are herein incorporated by reference in their entirety.

### TECHNICAL FIELD

The present disclosure relates to a work method for a Cartesian machine tool.

### BACKGROUND

A generic machine tool commonly operates according to a process, which here is described in general and independently of the nature of the workpiece, of its machining status or of the operations, e.g. milling, roughing, perforation, and the like, to be carried out on it, and which comprises the following steps:

switching on the machine tool: obviously the first action in any operating cycle is switching on the machine tool;

warm-up and self-diagnosis: once switched on, the machine carries out a series of operations adapted to bring it up to rated conditions and to check its status;

mounting on retainers of a workpiece: a workpiece to be machined is installed in the work area of the machine; the mounting on retainers can be done manually or automatically;

determining the “zeroes” of the workpiece being machined: once the workpiece is mounted on retainers, a point is inserted into the numerical control of the machine which will be the reference for the subsequent machining operations. The steps described up to here can be omitted if machining and/or re-machining operations are carried out on a workpiece that is already fixed, therefore already mounted on retainers, and/or with the machine already operational, i.e. with the warm-up already carried out;

starting machining: in this step the machine starts any machining cycle, with all the operations specified by the program in use: millings, roughings, perforations and the like;

carrying out a machining cycle: this step of the process is the one where the roughing machining effectively occurs, in which great quantities of material are removed and in which the machining tolerances are necessarily larger; this step also includes the pre-finishing machining, which makes it possible to have a known quantity of material, the “stock allowance”, which must then be detected by the subsequent step of measuring the workpiece prior to finishing.

measuring the workpiece prior to finishing: once the roughing machining and pre-finishing operations indicated in the previous step have concluded, the workpiece is measured for the purposes of finishing machining; such measurements are carried out using a measurement probe mounted on the working head;

carrying out a finishing cycle: on the basis of the measurement carried out in the previous step, the finishing machining operations to bring the workpiece to the final dimensions and tolerances are carried out;

measuring the finished workpiece: once the machining operations are ended, the workpiece is measured in order to have the final dimensions. Such final measurement can be carried out by an operator on board the machine or, by dismounting the workpiece, on an external measurement machine;

ending machining: irrespective of the method of final measurement, the workpiece is removed from the machine and the process concludes.

Such work method known today for machine tools, although normally used, presents some limitations.

One major limitation is constituted by the fact that the measurement probe, being mounted on the working head of the machine tool proper, is therefore moved using the same axes as the machine, and these axes are controlled with the same position transducers used in the mechanical machining operations.

Therefore the measurement is carried out with respect to the reference system of the machine and not with respect to an absolute reference system; any geometric errors in the machine, and as a consequence any geometric errors in the reference system, will therefore not be detected in this step.

It is however possible to use measurement methods that make it possible to rule out such errors or to measure their effects, for example by rotating the workpiece and using two different axes of the machine to carry out the same measurement.

But in the end, the measurement of the workpiece, carried out in the ways described above, has never been precise and reliable and it still requires direct control from a specialist operator.

From the process it can therefore be seen that the precision of the measurements carried out on board the machine is limited by the technology used to build the machine, insofar as it depends on using the reference system which is relative to the machine itself Techniques are known which are adapted to limit the extent of the imprecision owing to geometric errors, but they require the direct supervision of an operator and in any case they entail a point of discontinuity in the flow of the work process, for example to reposition the workpiece.

### SUMMARY

The aim of the present disclosure is to provide a work method for a Cartesian machine tool which is capable of improving the known art in one or more of the above mentioned aspects.

Within this aim, the disclosure provides a work method for a Cartesian machine tool which makes it possible to carry out measurements on board the machine the precision of which is not limited by the technology used to build that machine.

The disclosure also provides a work method that makes it possible to take measurements that are precise and reliable without requiring supervision by one or more specially-trained operators.

The disclosure further provides a method that does not entail points of discontinuity in the flow of the work process.

Furthermore, the present disclosure overcomes the drawbacks of the known art in a different manner to any existing solutions.

This aim and these and other advantages which will become better apparent hereinafter are achieved by providing a work method for a Cartesian machine tool comprising the following steps: starting machining of a workpiece; carrying out a machining cycle; carrying out a qualification operation, i.e., an operation to check a relative positioning system, on board the machine tool, by way of comparison with a positioning system with absolute reference for calibration, which is adapted to check the displacement of the indications of the positioning systems on board the machine, i.e., of the relative reference system, with respect to the positions of an absolute reference system for calibration; checking the outcome of the qualification operation; if the qualification operation is passed successfully, then proceed with an operation to measure the workpiece prior to finishing; if the qualification operation is passed successfully, then proceed with a compensation step, which comprises one or more compensation operations; carrying out a finishing cycle; measuring the finished workpiece; and ending machining.

### BRIEF DESCRIPTION OF THE DRAWING

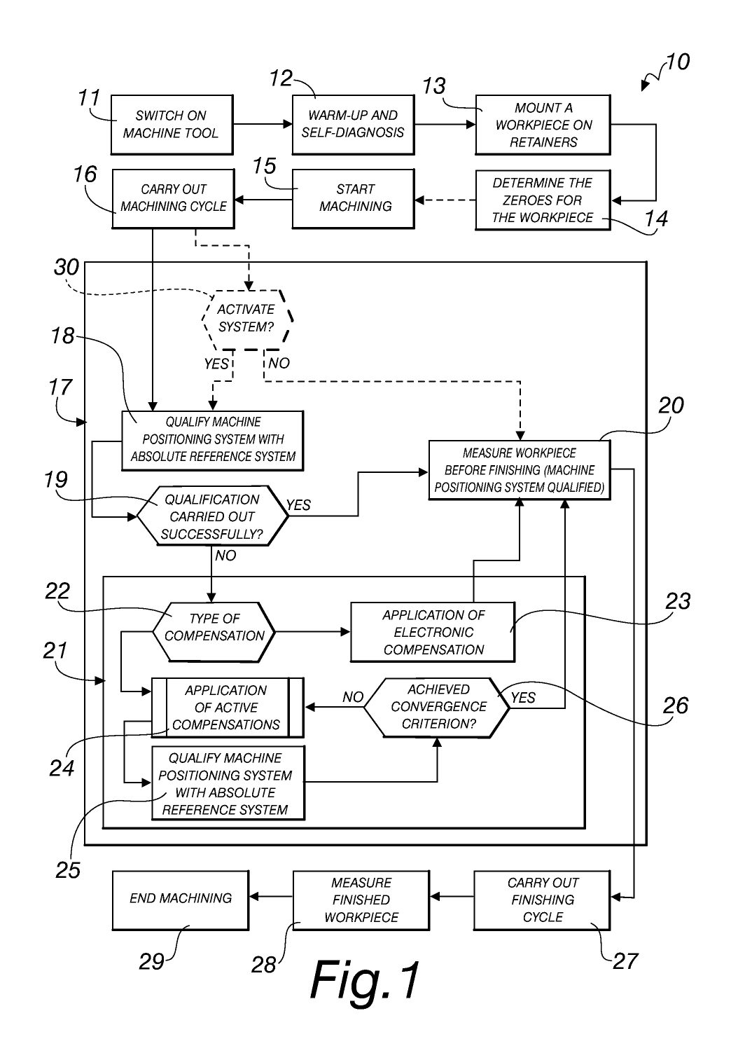

Further characteristics and advantages of the disclosure will become better apparent from the detailed description that follows of a preferred, but not exclusive, embodiment of the work method for a Cartesian machine tool according to the disclosure, which is illustrated, by way of non-limiting example, in the accompanying FIG. 1, in which such method is shown with a block diagram.

### DETAILED DESCRIPTION OF THE DRAWING

With reference to FIG. 1, the work method for a Cartesian machine tool according to the disclosure, generally designated by the reference numeral 10, comprises the following steps:

switching on the machine tool; such step is shown schematically by the block 11 in FIG. 1;

warm-up and self-diagnosis; such operations are configured so that the machine tool carries out a series of operations adapted to bring it up to rated conditions, i.e. to rated operating values, and to check its status; such step is shown schematically by block 12 in FIG. 1;

mounting on retainers of a workpiece, i.e. a workpiece to be machined is installed in the work area of the machine; the mounting on retainers can be done manually or automatically; such step is shown schematically by block 13 in FIG. 1;

once the workpiece is mounted on retainers, determining the zeroes of the workpiece, i.e. inserting a reference point into the numerical control of the machine tool for the subsequent machining operations; such step is shown schematically by block 14 in FIG. 1.

The steps described up to here can be omitted if machining and/or re-machining operations are carried out on a workpiece that is already fixed, therefore already mounted on retainers, and/or with the machine already operational, i.e. with the warm-up already carried out;

starting machining of a workpiece; in this step the machine tool starts any machining cycle, with all the operations specified by the program in use, such as for example millings, roughings, perforations and the like; such step is shown schematically by block 15 in FIG. 1.

carrying out a machining cycle; such step of the process is where the roughing machining effectively occurs, great quantities of material are removed and the machining tolerances are larger than the tolerances specified for the finished workpiece; typically, for a finished workpiece the finishing tolerances are in the order of hundredths of a millimeter, while the roughing tolerances are in the order of tenths of a millimeter; such step also comprises the pre-finishing machining, which makes it possible to have a known quantity of material, the “stock allowance”, which must then be detected by the subsequent step of measuring the workpiece prior to finishing; such step is shown schematically by block 16 in FIG. 1.

The work method 10 according to the disclosure has the peculiarity of comprising the following steps, which are shown schematically by block 17 in FIG. 1:

carrying out an operation to check a relative positioning system, on board the machine tool, by way of comparison with a positioning system with absolute reference for calibration; below such operation is referred to with the term “qualification”; this qualification operation serves to check the displacement of the indications of the positioning systems on board the machine, i.e., of the relative reference system, with respect to the positions of an absolute reference system for calibration, such as for example the system described in Italian patent application no. 102015000023588 of 15 Jun. 2015 in the name of HPT SINERGY S.R.L.; such step is shown schematically by block 18 in FIG. 1;

checking the outcome of the qualification operation; such step is shown schematically by block 19 in FIG. 1;

if the qualification operation is passed successfully, i.e. the displacement falls within a preset range of tolerances, then proceed with an operation to measure the workpiece prior to finishing, the latter operation being shown schematically by block 20 in FIG. 1;

if the qualification operation is not passed, then proceed with a compensation step, which comprises one or more compensation operations, which are shown schematically overall by block 21 in FIG. 1; such one or more compensation operations are constituted by corrective actions that the machine tool is capable of applying automatically in order to return the displacements that were detected during the qualification step 18 to within the preset tolerances.

The method 10 according to the disclosure includes for example the following types of compensation: electronic compensations and active compensations.

The compensation step 21 comprises an initial step of selecting the type of compensation operations from either electronic compensations or active compensations; such step is shown schematically by block 22 in FIG. 1.

The application of electronic compensations is shown schematically by block 23.

The application of active compensations is shown schematically by block 24.

Electronic compensation means a compensation that is adapted to correct the feedback loop of the numerical control of the machine tool, which is a typically electronic operation.

Such electronic compensation consists of setting up an array, i.e. a table, of independent displacements that makes each axis of the machine describe the correct, i.e. compensated, path using the displacements of the concurrent axes of the machine tool on the basis of the qualification cycle carried out with the absolute reference system for calibration; such electronic compensation has a direct effect on the movement of the axes of the machine tool, therefore, once applied, it is possible to proceed immediately with the measurement of the workpiece.

Such type of compensation has no effect on the actual geometry of the machine, which is not modified.

Active compensations consist of all the mechanical, electro-hydraulic etc. compensations that go to modify the geometry of the machine so as to recover the displacements measured during the qualification cycle.

Such compensations are indirect, in the sense that the correction occurs not through the modification of the path taken by the axes of the machine but through the use of active systems installed on board the machine tool which modify its actual geometry.

It is advisable, after an active compensation step, to qualify the geometry of the machine once again prior to proceeding to measure the workpiece.

Such types of compensation described above, and others which are understood to be similar and equivalent, can be applied in combination.

The method 10 also comprises the following operations:

if electronic compensations 23 have been carried out, which have a direct effect on the motion of the axes of the machine tool, then proceed with the operation to measure the workpiece prior to finishing, as in block 20;

if active compensations 24 have been carried out, then execute a further qualification step of the positioning system of the machine tool; such further qualification step is indicated by block 25; such operation corresponds to the one described above, but is executed on the machine tool that has been actively compensated following active compensation operations; such further qualification 25 is carried out in order to be certain that the active compensation step is carried out correctly;

checking the outcome of the new further qualification operation 25; such operation is shown schematically by block 26;

if the further qualification operation 25 is not passed, i.e., in the event of undercompensation or overcompensation, then proceed with a new active compensation 24;

carrying out a new further qualification step 25 and a new further active compensation 24, iterating these two operations until a convergence is achieved of the data related to the displacements, i.e. related to the position errors, i.e. these displacement data converge once they are returned to the respective tolerance intervals;

if the qualification is passed successfully, i.e. the displacement falls within the permitted tolerances, then proceed with the operation to measure the workpiece prior to finishing 20.

The operating step of measuring the workpiece 20, prior to machining or prior to finishing, is carried out by using the relative reference system, i.e. controlled axes of the machine tool are still used, but aligned and conveniently calibrated with respect to an absolute reference system.

The measurement of the workpiece thus obtained has a very high degree of precision.

The work method according to the disclosure 10 comprises the following final steps:

carrying out a finishing cycle; on the basis of the measurement carried out in the previous step, the finishing machining operations to bring the workpiece to the final dimensions and tolerances are carried out; such step is shown schematically by block 27;

measuring the finished workpiece; once the machining operations are ended, the workpiece is measured in order to have the final dimensions. Such final measurement can be carried out by an operator on board the machine or, by dismounting the workpiece, on an external measurement machine; such step is shown schematically by block 28;

ending machining; irrespective of the method of final measurement, the workpiece is removed from the machine and the process concludes, a step shown schematically by block 29.

Since the machine tool is compensated, it is left to the discretion of the user whether to use the machine tool again to measure the final dimensions of the finished piece or whether to use an external measurement machine.

The work method according to the disclosure can comprise a further step of selecting whether or not to use a positioning system with absolute reference for calibration; such step of selecting is shown schematically by the dotted block 30.

If it is decided to use a positioning system with absolute reference for calibration, then proceed from the step of carrying out a machining cycle 16 to the qualification step 18.

If it is decided not to use a positioning system with absolute reference for calibration, then proceed directly from the step of carrying out a machining cycle 16 to the step of measuring the workpiece prior to finishing 20.

Such choice can be defined by the machine operator.

Alternatively, the step of selecting 30 is carried out by an electronic control unit, which has a preset algorithm, for example designed to process data relating to the ambient temperature in order to check whether such ambient temperatures have undergone major variations over a determined time period.

If the cycle comprising the qualification operation 18, checking the qualification 19, and applying any compensations 21 is not activated, then the process proceeds with the measurement prior to finishing 20 and the finishing machining 27.

With the work method 10 according to the disclosure it is possible to achieve a much greater accuracy of measurement than using the positioning systems of a machine tool alone; such result can be achieved without removing the workpiece from the machine, with considerable saving of time and of complications owing to repositioning of the workpiece; finally, the entire operation can be automated and integrated in the work process.

The integration of a positioning system with absolute reference for calibration in the work process makes it possible to obtain measurements that are precise, reliable, and do not require supervision; the system in fact measures the geometric errors of the machine tool by returning in this manner the relative reference system of the machine to an absolute reference, for example associated with the footing of the machine itself, in this way the dimensions of the workpiece obtained by the measurement probe are purged of errors and/or contributions of the machine.

In practice it has been found that the disclosure fully achieves the intended aims and advantages.

In particular, with the disclosure a work method for a Cartesian machine tool has been devised that makes it possible to carry out measurements on board the machine the precision of which is not limited by the technology used to build that machine.

What is more, with the disclosure a work method has been devised that makes it possible to take measurements that are precise and reliable without requiring supervision by one or more specially-trained operators.

Furthermore, with the disclosure a method has been devised that does not entail points of discontinuity in the flow of the work process, since the precision is achieved without removing the workpiece being machined from the support means to which it is fixed, or modifying its position.

The disclosure, thus conceived, is susceptible of numerous modifications and variations. Moreover, all the details may be substituted by other, technically equivalent elements.

In practice the elements employed, provided they are compatible with the specific use, and the contingent dimensions and shapes, may be any according to requirements and to the state of the art.

1. A work method for a Cartesian machine tool, comprising the following steps:
starting machining of a workpiece;
carrying out a machining cycle;
carrying out a qualification operation, i.e., an operation to check a relative positioning system, on board the machine tool, by way of comparison with a positioning system with absolute reference for calibration, which is adapted to check the displacement of the indications of the positioning systems on board the machine, i.e., of the relative reference system, with respect to the positions of an absolute reference system for calibration;
checking the outcome of the qualification operation;
if the qualification operation is passed successfully, then proceed with an operation to measure the workpiece prior to finishing;
if the qualification is not passed, then proceed with a compensation step, which comprises one or more compensation operations;
carrying out a finishing cycle;
measuring the finished workpiece; and
ending machining.

2. The method according to claim 1, wherein the one or more compensation operations of the compensation step comprise corrective actions that the machine tool is capable of applying automatically in order to return the displacements that were detected during the qualification step to within the preset tolerances.

3. The method according to claim 1, wherein the method provides for the following types of compensation, electronic compensations and active compensations.

4. The method according to claim 1, wherein the compensation step further includes an initial step of selecting the type of compensation operations from electronic compensations and active compensations.

5. The method according to claim 3, further comprising the following operations:
if electronic compensations have been carried out, which have a direct effect on the motion of the axes of the machine tool, then proceed with the operation to measure the workpiece prior to finishing;
if active compensations have been carried out, then execute a further qualification step of the positioning system of the machine tool;
checking the outcome of the new further qualification operation;
if said further qualification operation is not passed, i.e., in the event of undercompensation or overcompensation, then proceed with a new active compensation;
carrying out a new further qualification step and a new further active compensation, iterating these two operations until a convergence is achieved of the data related to the displacements;
if the qualification is passed successfully, then proceed with said operation to measure the workpiece prior to finishing.

6. The method according to claim 1, wherein said operating step of measuring the workpiece, prior to machining or prior to finishing, is carried out by using the relative reference system, which is aligned and calibrated with respect to an absolute reference system.

7. The method according to claim 1, further comprising the following final steps:
executing a finishing cycle;
measuring the finished workpiece; and
ending machining.

8. The method according to claim 7, further comprising a further step of selecting whether or not to use a positioning system with absolute reference for calibration.

9. The method according to claim 8, wherein the step of selecting entails:
if it is decided to use a positioning system with absolute reference for calibration, then proceed from the step of carrying out a machining cycle to the qualification step;
if it is decided not to use a positioning system with absolute reference for calibration, then proceed directly from the step of carrying out a machining cycle to the step of measuring the workpiece prior to finishing.

10. The method according to claim 8, wherein said step of selecting is carried out by an electronic control unit.
